(19) United States
(12) Patent Application Publication
(10) Pub. No.: US 2006/0068278 A1
(43) Pub. Date: Mar. 30, 2006

(54) Vehicle battery pack insulator

(76) Inventors: Richard L Bloom, Woodville, WI (US); Michael Patrick M, West St. Paul, MI (US); Dennis C Teschendorf, Rochester Hills, MI (US)

Correspondence Address: 3M INNOVATIVE PROPERTIES COMPANY, PO BOX 33427, ST. PAUL, MN, 55133-3427, US

(21) Appl. No.: 10/540,243

(22) PCT Filed: Dec. 31, 2003
(86) PCT No.: PCT/US03/41696

§ 371 Date: Jun. 22, 2005

Related U.S. Application Data
(60) Provisional application No. 60/437,795, filed on Jan. 4, 2003.
(60) Provisional application No. 60/444,428, filed on Feb. 3, 2003.

(51) Int. Cl. H01M 2/02; H01M 10/50

(52) U.S. Cl. 429/176; 429/120

(57) ABSTRACT

A vehicle battery pack insulator and insulated battery pack for a vehicle are disclosed. Methods of insulating a battery pack type power supply in a vehicle are also disclosed. Vehicles containing an insulated battery pack type power supply are further disclosed.

### CROSS REFERENCE TO RELATED APPLICATIONS

This application claims the benefit of priority to U.S. Provisional Patent Application No. 60/444,428, filed on Feb. 03, 2003 and U.S. Provisional Patent Application No. 60/437,795, filed on Jan. 4, 2003, the subject of both of which is hereby incorporated by reference in its entirety.

### FIELD OF THE INVENTION

The present invention relates to battery pack type power supplies for vehicles and the like, more particularly, to such battery pack type power supplies that are insulated and, even more particularly, to the insulation used for such battery pack type power supplies. The present invention also relates to methods of insulating a battery pack type power supply in a vehicle and the vehicle containing such an insulated battery pack type power supply.

### BACKGROUND OF THE INVENTION

Vehicles containing battery pack type power supplies, such as hybrid vehicles (i.e., vehicles that use electricity alone or in combination with gasoline or diesel fuel) may be exposed to extreme temperatures ranging from, for example, as low as −40° C. to as high as 50° C.

There is a need in the art of battery pack type power supplies for thermal insulating elements capable of insulating battery pack type power supplies exposed to a wide temperature range.

### SUMMARY OF THE INVENTION

The present invention is directed to an insulating element for a battery pack, wherein the insulating element comprises inorganic fibers in the form of a thin sheet, mat or any other thin-walled structure. The inorganic fibers may be ceramic fibers, glass fibers, or mixtures thereof. The ceramic fibers can be refractory ceramic fibers. An organic binder can be used to hold the inorganic fibers together and maintain the insulating element in a highly dense and thin state. Examples of inorganic fiber-containing sheets include, for example, the ceramic fiber sheets or layers disclosed and taught in U.S. Pat. Nos. 5,380,580 and 4,863,700, and PCT Published Patent Application No. WO 00/75496 A1, the subject matter of each of which is incorporated herein by reference in its entirety. It is desirable for the insulating element to be suitable for insulating a battery pack in a vehicle.

In one embodiment of the present invention, the insulating element suitable for use with a battery pack comprises (i) a lower sheet member, (ii) at least one side wall sheet member, and (iii) an upper sheet member, wherein each sheet member comprises a sheet or mat of inorganic fibers, and wherein the sheet members of the insulating element combine with one another to form an insulated cavity bounded by (i) the lower sheet member, (ii) the at least one side wall sheet member, and (iii) the upper sheet member. In some embodiments of the present invention, the insulating element comprises (i) a lower sheet member, (ii) an upper sheet member, and (iii) at least one side wall sheet member attached to the lower sheet member, the upper sheet member, or both, wherein each sheet member comprises a sheet or mat of inorganic fibers, and the combination of sheet members forms an insulated cavity. In other embodiments of the present invention, the insulating element comprises a single sheet member having sheet components, which form an insulated cavity bounded by portions of the single sheet member.

In a further embodiment of the present invention, the insulating element comprises (i) a lower sheet member, (ii) at least one side wall sheet member, and (iii) an upper sheet member as described above, wherein one or more sheet members further comprise an attaching member on the sheet member opposite the insulating cavity. Suitable attaching members include, but are not limited to, a pressure-sensitive adhesive layer, a hot melt adhesive layer, a structural adhesive layer, a hook and loop type fastener, a headed fastener, or a combination thereof. In one desired embodiment, one or more sheet members comprise an attaching member in the form of a pressure-sensitive adhesive layer on the sheet member opposite the insulating cavity.

In yet a further embodiment of the present invention, the insulating element comprises a molded insulating element for a battery pack. The molded insulating element may comprise one or more molded sheet members, wherein each sheet member comprises a sheet or mat of inorganic fibers, and the sheet members combine with one another to form an insulated cavity bounded by (i) a lower sheet member, (ii) at least one side wall sheet member, and (iii) an upper sheet member. In one desired embodiment of the present invention, each sheet member of the molded insulating element comprises a molded sheet member.

The present invention is further directed to an insulating element assembly comprising an insulating element in combination with a housing, wherein the housing comprises (i) a lower tray, (ii) one or more side walls, one or more of which may be attached to the lower tray or to an attachable lid, and (iii) an attachable lid that is attachable to the lower tray, the one or more side walls, or both. The housing components may be attached to one another to form a tray cavity suitable for containing an insulating element. In one desired embodiment of the present invention, an insulating element fits snugly in the tray cavity such that substantially all of the inner surface area of the tray cavity is covered by the insulating element.

The present invention is even further directed to an insulated battery pack assembly for a vehicle comprising the above-described insulating element in combination with a battery pack. The insulated battery pack assembly of the present invention may further comprise the above-described housing.

The present invention is also directed to a vehicle comprising the above-described insulating element, insulating element assembly, or insulated battery pack assembly. In one embodiment of the present invention, the vehicle comprises a hybrid vehicle capable of being powered by any combination of diesel, gas and electricity or the like.

The present invention is also directed to methods of making insulating elements, insulating element assemblies, and battery pack assemblies as described above, as well as, methods of insulating a battery pack in a vehicle. In one exemplary method of the present invention, the method of insulating a battery pack comprises at least partially enclosing a battery pack in an insulating cavity formed by the above-described insulating element so as to insulate the battery pack from undesirably low temperatures.

These and other features and advantages of the present invention will become apparent after a review of the following detailed description of the disclosed embodiments and the appended claims.

### BRIEF DESCRIPTION OF THE DRAWINGS

FIG. 1 is a partial cross-sectional view of a battery pack assembly or power supply apparatus insulated according to one embodiment of the present invention and mounted in a vehicle;

FIG. 2 is a frontal view of an exemplary insulating element according to one embodiment of the present invention;

FIG. 3 is a view of the exemplary insulating element of FIG. 2 and an insulating cavity at least partially surrounded by the exemplary insulating element;

FIG. 4 is a partial cross-sectional view of a lid for a battery pack assembly or power supply apparatus insulated according to a specific embodiment of the present invention;

FIG. 5 is a perspective view of an exemplary tray for receiving a battery pack assembly;

FIG. 6 is a perspective view of a sheet of an insulating element designed for being mounted onto an upper surface of the exemplary tray of FIG. 5;

FIG. 7 is a perspective view of a sheet of an insulating element designed for being mounted onto an inner surface of a lid for the exemplary tray of FIG. 5; and

FIG. 8 is a graph comparing the thermal transmission characteristics of two exemplary sheets of insulation materials suitable for use in an insulating element of the present invention.

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

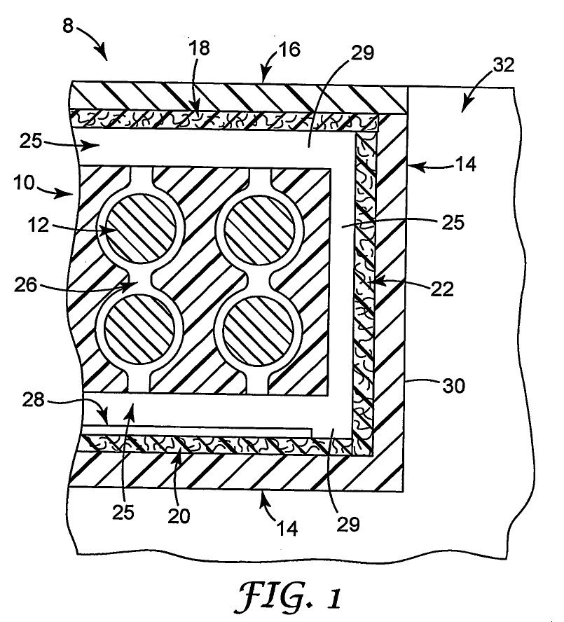

Referring to FIG. 1, an exemplary battery pack assembly or power supply apparatus 8, such as that used in hybrid vehicles, which run on gas (or diesel) and electricity, includes a battery pack 10 containing a plurality of power modules 12 mounted in a tray 14 having a lid 16 and insulated with an inorganic fiber-containing insulating element according to the present invention. Such an inorganic fiber-containing insulating element can be, for example, in the form of a sheet, a mat, or any other desired thin-walled structure. Such trays 14 can be made of a plastic, a metal (such as, for example, iron, steel, aluminum, magnesium, etc.) or a combination thereof. The exemplary insulating element shown includes a sheet 18 of inorganic fibers mounted onto (e.g., bonded to) the underside of lid 16 and a sheet 20 of inorganic fibers mounted onto (e.g., bonded to) an upper surface of tray 14. The insulating element may also include a sheet 22 of inorganic fibers, or some other suitable insulating material, mounted onto (e.g., bonded to) one or more or all of the side walls of tray 14.

In order to maintain battery pack 10 within a desired temperature range, air may be circulated through passages 25 and ducts 26 to cool battery pack 10, a heater 28 (e.g., a wire heating element) may be activated to warm battery pack 10, or both may be utilized, as necessary. Desirably, battery pack 10 is positioned within an insulating cavity 29 surrounded by sheets 18, 20 and 22 so that air can flow within passages 25 surrounding battery pack 10. The tray 14 is designed so as to be received and mounted within a well or cavity 30 formed in the body 32 of a vehicle. Each of the above-mentioned components forming a battery pack assembly is described in more detail below.

I. Insulating Element

The insulating element of the present invention comprises one or more sheets, mats or other thin-walled fiber-containing structures, each of which contains inorganic fibers. Each sheet or mat may have a desired shape and size for an intended purpose, such as for insulating a portion of a battery pack or the entire outer surface of a battery pack. The one or more sheets, mats or other thin-walled structures may be attached to one another or positioned relative to one another, but unattached, so as to provide an insulating cavity. The insulating cavity formed by the one or more sheets, mats or other thin-walled structures insulates any object, such as a battery pack, positioned within the insulating cavity as described below.

A. Insulating Element Configurations

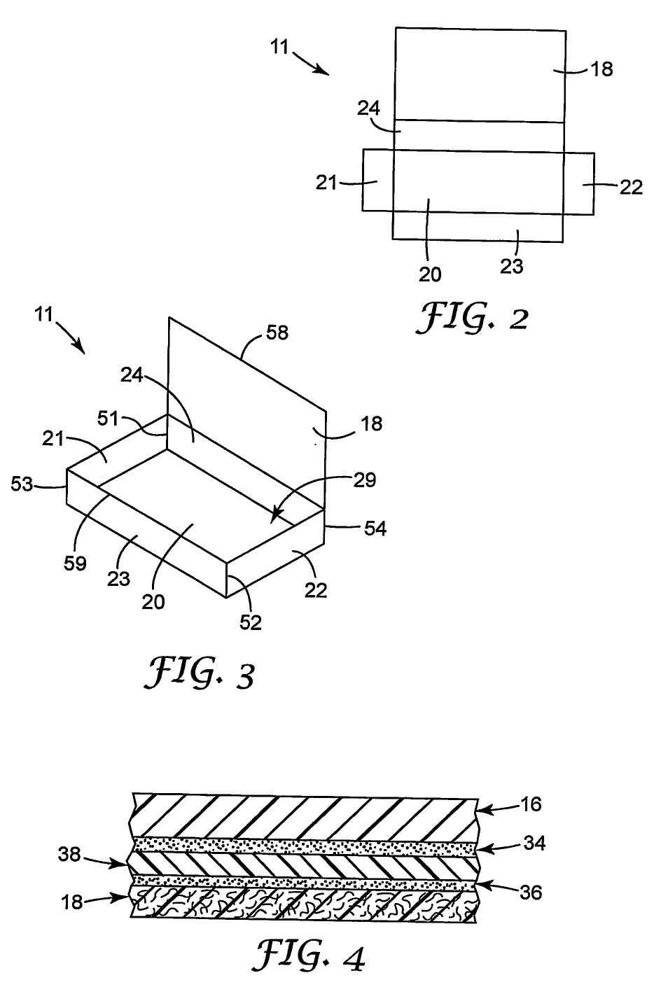

In one exemplary embodiment of the present invention, the insulating element for a battery pack comprises (i) a lower sheet member, (ii) at least one side wall sheet member, and (iii) an upper sheet member, wherein the sheet members of the insulating element may be combined with one another to form an insulated cavity bounded by (i) the lower tray sheet member, (ii) the at least one side wall sheet member, and (iii) the upper lid sheet member. In one desired embodiment of the present invention, the insulating element comprises (i) a lower sheet member, (ii) at least one side wall sheet member attached to the lower sheet member and/or an upper sheet member, and (iii) an upper sheet member attached to the at least one side wall sheet member, the lower sheet member, or both, wherein the sheet members of the insulating element may be combined with one another to form an insulated cavity bounded by (i) the lower tray sheet member, (ii) the at least one side wall sheet member, and (iii) the upper sheet member. An exemplary insulating element of the present invention is shown in FIG. 2.

As shown in FIG. 2, exemplary insulating element 11 comprises one or more sheets 18 and 20-24. In one embodiment of the present invention, exemplary insulating element 11 comprises six separate sheets 18 and 20-24, which may be (i) separate from one another (i.e., not attached to one another), (ii) attached to one another such that more than one but less than six sheets are attached to one another, or (iii) attached to one another such that all six sheets are attached to one another. In a further embodiment of the present invention, exemplary insulating element 11 comprises a single sheet having six distinct sheet components (i.e., components 18 and 20-24) as shown in FIG. 2. Desirably, exemplary insulating element 11 comprises a single sheet of inorganic fibers having components 18 and 20-24.

Exemplary insulating element 11 of FIG. 2 comprises lower sheet member 20, side wall sheet members 21-24 attached to lower sheet member 20, and upper sheet member 18 attached to at least one side wall sheet member, in this case, side wall sheet member 24. As shown in FIG. 3, exemplary insulating element 11 forms an insulated cavity 29 bounded by (i) lower sheet member 20, (ii) side wall sheet members 21-24, and (iii) upper sheet member 24. Side wall sheet members 21-24 may be unattached to one another, only coming into close proximity and/or contact with one another. Alternatively, side wall sheet members 21-24 may be attached to one another along seams 51-54 shown in FIG. 3. Suitable methods of attaching adjacent side wall sheet members to one another include, but are not limited to, adhesive bonding, stitching, stapling, etc.

As shown in FIG. 3, exemplary insulating element 11 forms a substantially enclosed insulated cavity 29 by folding upper sheet member 18 over insulated cavity 29 so that edge 58 of upper sheet member 18 comes into close proximity to and/or into contact with edge 59 of side wall sheet member 23. Insulated cavity 29 is suitable for containing and insulating an object, such as a battery pack, from undesirably cold and/or hot temperatures.

In one exemplary embodiment of the present invention, the insulating element, such as exemplary insulating element 11 shown in FIG. 3, may comprise a molded insulating element. The molded insulating element may comprise one or more molded sheet members, wherein each sheet member comprises a sheet or mat of inorganic fibers, and the sheet members combine with one another to form an insulated cavity bounded by (i) a lower sheet member, (ii) at least one side wall sheet member, and (iii) an upper sheet member. In one desired embodiment, each of the one or more sheet members forming the insulating element comprises a molded sheet member. The combination of one or more molded sheet members and any other sheet members (i.e., non-molded sheet members), when present, forms an insulating cavity suitable for insulating an object, such as a battery pack.

In one desired embodiment of the present invention, the molded insulating element comprises (i) a lower sheet member, (ii) at least one side wall sheet member attached to the lower sheet member and/or an upper sheet member, and (iii) an upper sheet member attached to the at least one side wall sheet member, the lower sheet member, or both, wherein at least a portion of the at least one side wall sheet member is in a plane substantially perpendicular to the lower sheet member, and the upper sheet member is foldable into a plane substantially parallel to the lower sheet member. The at least one side wall sheet member may comprise two or more unconnected side walls along a perimeter of the lower sheet member, or may comprise a single side wall that extends along the entire perimeter of the lower sheet member.

It should be noted that the insulating element of the present invention may have a variety of configurations, and that exemplary insulating element 11 shown in FIGS. 2-3 is only one example of an insulating element of the present invention. For example, the insulating element may comprise a single side wall extending along a perimeter of the lower sheet member, such as when the lower sheet member has a circular shape. In other embodiments, the insulating element may comprise eight or more side walls extending along a perimeter of the lower sheet member, such as when the lower sheet member has an octagonal shape. Further, the one or more side walls may extend along a perimeter of the upper sheet member as oppose to the lower sheet member as shown in FIGS. 2-3. In other embodiments, both the lower sheet member and the upper sheet member may have one or more side wall sheet members extending along the perimeters of the lower sheet member and the upper sheet member. Any combination of a lower sheet member, side wall sheet member(s), and an upper sheet member may be used in the present invention as long as the combination forms an insulating cavity suitable for insulating an object, such as a battery pack.

B. Insulating Element Materials

The insulating elements of the present invention comprise inorganic fibers. Suitable inorganic fibers for use in the present invention may include, but are not limited to, oxide and non-oxide ceramic fibers such as, for example, alumina fibers, aluminosilicate fibers, glass fibers, graphite fibers, boron fibers, alumina borosilicate fibers, calcia-magnesium silicate fibers, silicon carbide fibers, annealed ceramic fibers, quartz fibers, and mixtures thereof. In one exemplary embodiment of the present invention, each sheet or mat comprises ceramic fibers, glass fibers, or a combination thereof. Commercially available fibers that may be useful include, but are not limited to, CERAFIBER™ aluminosilicate fibers available from Thermal Ceramics (Augusta, Ga.), FIBERFRAX™ 7000M aluminosilicate fibers available from Unifrax Corporation (Niagara Falls, N.Y.), alumina fibers available under the SAFFIL™ trade designation from Dyson Inc. (Wiltshire, UK), and NEXTEL™ fibers available from 3M Company (St. Paul, Minn.).

The sheets, mats or other thin-walled structures used to form the insulating element of the present invention may comprise a variety of fiber-containing configurations. Typically, each sheet, mat or other thin-walled structure comprises a nonwoven fabric, a woven fabric, a knitted fabric, a unidirectional fabric, a scrim, a mesh, or a combination thereof. Desirably, each sheet, mat or other thin-walled structure comprises a nonwoven fabric, such as a needlepunched or hydroentangled nonwoven fabric. Combinations of nonwoven fabrics with other fabrics may also be used, such as a fiber batt of inorganic fibers sandwiched between outer layers of polymeric film, spunbonded polymeric fibers, such as polyester spunbonded fabrics, or other fiber-containing layers.

Typically, each sheet or mat of the insulating element of the present invention has an overall average sheet thickness of up to about 10 mm. Depending on the end use and the materials used, each sheet or mat of the insulating element may have an average sheet thickness as low as about 1.0 mm. Desirably, each sheet or mat of the insulating element has an average sheet thickness of from about 2.0 mm to about 5.0 mm, more desirably, from about 3.0 mm to about 4.0 mm.

The sheets, mats or other thin-walled fiber-containing structures used to form the insulating element of the present invention may further comprise one or more additional optional components including, but not limited to, a binder material to assist in bonding of inorganic fibers to one another, a filler material, other fibers, such as polymeric fibers, or a combination thereof. Suitable binder materials include, but are not limited to, organic polymers or oligomers that are solvent-based or aqueous-based materials. Aqueous-based materials are desired for environmental reasons, and may include acrylics, ethylene vinyl acetates, polyurethanes, and synthetic rubbers, e.g., styrene butadiene rubbers, or styrene acrylonitrile rubbers.

In one embodiment of the present invention, each sheet or mat used to form the insulating element of the present invention comprises inorganic fibers and thermoplastic polymeric fibers, which act as a binder for adhering the inorganic fibers to one another. In this embodiment, the sheets or mats may be thermoformed to form sheets of mats having enhanced structural integrity. When present, the thermoplastic polymeric fibers desirably comprise up to about 40 percent by weight (pbw) based on a total weight of the sheet or mat.

In one desired embodiment of the present invention, each sheet, mat or other thin-walled fiber-containing structure used to form the insulating element of the present invention comprises sized or unsized inorganic fibers without additional components, such as binders. In this embodiment, the inorganic fibers are mechanically bonded to one another, such as via a needlepunching, a hydroentangling or a stitchbonding operation. Each sheet, mat or other thin-walled fiber-containing structure used to form the insulating element of the present invention may comprise, consist essentially of, or consist any combination of sized or unsized inorganic fibers selected from the inorganic fibers described above.

C. Methods for Making an Insulating Element

The insulating element of the present invention is desirably formed from inorganic fibers that have been constrained to control the bulkiness of the fibers, i.e., to minimize the thickness of the insulating element, while providing sufficient insulation to desirably allow a temperature of the battery pack to be controlled within a narrow temperature range during operation. The fibers can be constrained in a number of ways including those known in the art. Such methods include, but are not limited to, (i) forming a wet laid paper or sheet of inorganic fibers, such as ceramic fibers, with an optional binder, (ii) needle punching a fiber batt of inorganic fibers that may have an optional sheet material (e.g., an additional fabric of inorganic or other fibers in the form of a woven, nonwoven, knitted, scrim or mesh fabric) on one or both sides, (iii) stitchbonding a fiber batt of inorganic fibers, (iv) enclosing inorganic fibers in a pouch or bag having a desired shape for the resulting insulating element, and (v) molding a sheet or mat of inorganic fibers, such as ceramic fibers, with an optional binder.

In an exemplary wet-laid paper process, inorganic fibers are mixed with a binder to form a slurry, the binder is coagulated if needed, and the slurry is cast onto a screen of a paper making machine, e.g., a Fourdrinier machine. The slurry may further contain a coagulating agent, a surfactant, a filler, organic fibers, defoamers, or a combination thereof. A typical coagulating agent is alum. The paper is then dewatered and dried for further processing if so desired, such as a molding or needlepunching process.

The insulating element may also be formed by stitchbonding or needlepunching a inorganic fiber batt. The batt may include a sheet material on one or both major surfaces of the batt. Sheet materials that may be used include, but are not limited to, polymeric films, woven textiles, and nonwoven textiles.

A molded insulating element may also be formed using a number of methods. In one molding operation, a mold/die and vacuum are used to dewater a slurry in the shape of the mold/die. Such a molding process is similar to the vacuum technology developed at Danser Inc. (Parkersburg, W. Va.) and described in U.S. Pat. No. 6,596,120, the subject matter of which is hereby incorporated by reference in its entirety. In one such exemplary method, an internal skeleton is designed and constructed to allow the desired vacuum pull/vacuum distribution through the part. The outside section of the die is in the form of a battery pack or sections of a battery pack for a multipart construction. After the die having the desired size and shape is submerged into the slurry, a part of the desired fiber weight, thickness and density is produced. In addition to the influence of the die, the physical properties of the part are primarily controlled by dipping time and slurry characteristics. The formed part in a wet condition is then released from the forming die and dried in an oven or other available drying procedures.

Another exemplary forming process involves molding the part directly into a battery pack housing component. In this process, the die “set-up” is comprised of two parts (i) the actual battery housing component and (ii) a die having the general shape of the housing component. The die can be either smaller or larger depending on the desired “fit” inside the housing component. The die is of the same construction as the die discussed above, i.e. multicomponent with at least an inner skeleton for the vacuum system and an outer shell in the form of the battery pack housing component. The desired process is for the actual housing component to be set-up relative to the die such that slurry can move easily into the open cavity that is created once the set-up is introduced into the slurry. The set-up is dipped into the slurry and vacuum is pulled for the desired amount of time that is determined by the slurry properties and target physical properties for the battery pack insulation (e.g., weight, thickness, profile, etc.). Once the dip and vacuum process is completed, the set-up is lifted from the slurry and the housing component is pulled up (via hydraulics or other appropriate means) such that the insulation fits securely inside the housing component. Simultaneously, air is blown out of the inner die to release the insulation into the housing component. The housing component containing the insulation is then released and dried via various drying processes.

D. Other Insulating Element Components

In some exemplary embodiments of the present invention, the insulating elements comprise one or more sheets or mats of inorganic fibers, wherein each sheet or mat comprises one or more fiber-containing layers as described above (e.g., a fiber batt of inorganic fibers alone or sandwiched between other layers, such as polyester spunbonded fabrics). In other embodiments of the present invention, the insulating elements include additional non-fibrous layers. In one exemplary embodiment, the insulating element of the present invention includes an attaching member used to attach the insulating element to one or more desired surfaces, such as a surface of a housing component (i.e., a tray, side wall, and/or lid) of a battery pack assembly. The attaching member may be an adhesive, such as, for example, a pressure-sensitive adhesive, a hot melt adhesive, or a structural adhesive, a mechanical fastener such as, for example, a hook and loop type fastener like SCOTCHMATE™ Fasteners or headed fasteners such as DUAL LOCK™ Fasteners, both available from 3M Company (St. Paul, Minn.), or any combination thereof.

Examples of pressure-sensitive adhesives (PSAs) include, but are not limited to, acrylic PSAs, tackified block copolymer PSAs, polyurethane PSAs, polyamide PSAs, polyolefin PSAs such as ethylene vinyl acetate PSAs, and the like. The type of adhesive suitable for bonding to a housing component may depend upon the material of the walls of the housing component, e.g., high surface energy plastics, low surface energy plastics, metal, etc. The adhesive may be applied directly to the sheet of the insulating element, to a primer on the sheet of the insulating element, or to a barrier layer on the sheet of the insulating element. Alternatively, the adhesive may be applied to a surface of the housing component so that the insulating element can be attached to the housing with the adhesive. The adhesive may be sprayed on, coated on, or supplied as a transfer adhesive or double coated tape and laminated to the sheet of the insulating element, or the housing component. Adhesive transfer tapes are available from 3M Company under the 3M™ trade designation under the product numbers such as Adhesive Transfer Tape 468MP, Adhesive Transfer Tape 468MPF, Adhesive Transfer Tape 966, and the like. Other suitable adhesives are also commercially available from suppliers of adhesives in various forms. Hot melt adhesives such as polyester film adhesives, film adhesives, and thermoset film adhesives are commercially available from Bostik Findley, Inc. (Middleton, Mass.).

Suitable pressure-sensitive adhesives may include both water-based adhesives, e.g. latex, and solvent-based adhesives. Suitable pressure-sensitive adhesives for use in the present invention include, but are not limited to, pressure-sensitive adhesives disclosed in U.S. Pat. Nos. Re 24,906 (Ulrich), U.S. Pat. No. 4,181,752 (Martens et al.), U.S. Pat. No. 5,602,221 (Bennett et al.), and U.S. Pat. No. 5,637,646 (Ellis), the subject matter of each of which is hereby incorporated in its entirety by reference.

Hot melt adhesives may be pressure-sensitive or heat-activated, i.e., non-tacky at room temperature. Suitable hot melt adhesives for use in the present invention include, but are not limited to, hot melt adhesives disclosed in U.S. Pat. Nos. 4,833,179 (Young et al.), U.S. Pat. No. 6,630,531 (Khandpur et al.), and U.S. Pat. No. 6,294,249 (Hamer et al.), the subject matter of each of which is hereby incorporated in its entirety by reference.

Structural adhesives include adhesives that cure to a thermoset matrix and include epoxy adhesives and polyurethane adhesives. The adhesives may be applied as a 100% solids adhesive, solvent-based adhesive, or water-based adhesive, using conventional coating or spraying processes, or as a film adhesive, which may be laminated. Curable solids adhesives are available as one or two-part systems that are cured with heat, and or light, e.g., UV light. Suitable curable adhesives include, but are not limited to, those disclosed in U.S. Pat. Nos. 5,536,805 (Kangas), U.S. Pat. No. 5,472,785 (Stobbie et al.), and EP 620,259 (George et al.). Film adhesives may be partially cured to provide a cohesive film, or they may include a curable component and a thermoplastic component, which after curing, form a thermoset matrix. Suitable structural film adhesives for use in the present invention include, but are not limited to, structural adhesive films commercially available from 3M Company such as 3M™ Scotch-Weld™ Structural Adhesive Film AF 126 Red, 3M™ Scotch-Weld™ Structural Adhesive Film AF 111, 3M™ Scotch-Weld™ Structural Adhesive Film AF 42, and 3M™ Scotch-Weld™ Structural Adhesive Film AF 46.

Other layers may also be included in the insulating element for various purposes. Such layers include, but are not limited to, primers to enhance the adhesion of other layers to the insulating sheets or mats of inorganic fibers or other layers, protective films or textiles (e.g., release liners) on surfaces of exposed adhesive layers, and protective coatings. Further, for additional insulation, a reflective coating/film such as that described in U.S. Pat. No. 3,591,400, the subject matter of which is hereby incorporated by reference in its entirety, can be applied to an inner surface of one or more sheets of the insulating element (i.e., the surface facing an insulating cavity and/or a battery pack). Such a reflective coating/film may be applied to the one or more sheets using known coating techniques including, but not limited to, roll coating, knife coating, and die coating.

The insulating element may include more than one non-fibrous layer and/or adhesive layer. In some instances, additional layers of adhesive may by used to enhance the bond of the pressure-sensitive adhesive to the insulating element. For example, a layer of hot melt adhesive may be applied to the insulating element either by directly coating the hot melt adhesive onto the insulating element, or by laminating a layer of hot melt adhesive or thermoset adhesive onto the insulating element, and the pressure-sensitive adhesive can be coated or laminated onto the hot melt or thermoset adhesive layer. As another illustration, a layer of plastic film, e.g., cast polypropylene film, may be laminated to the insulating element using a hot melt adhesive or thermoset adhesive, and a pressure-sensitive adhesive can be subsequently coated onto or laminated to the plastic film. In these cases, the hot melt adhesive, the thermoset adhesive, and the plastic film provide a smoother surface to allow better anchorage of the pressure-sensitive adhesive to the fibers in the insulating element. Further, the sheet members of the insulating element may be attached to a layer that adheres to the fibers of the sheet member, such as a hot melt adhesive, thermoset adhesive, plastic film, a nonwoven scrim, and later attached to a housing component using adhesive applied to either the surfaces of the housing component or to the sheet member of the insulating element. Suitable adhesives for this type of application include the adhesive transfer tapes described above, as well as, spray adhesives such as 3M™ General Purpose 45 Spray Adhesive.

One exemplary insulating element configuration is shown in FIG. 4. Referring to FIG. 4, sheet 18 may be mounted on an inner surface of lid 16 using a layer 34 of a pressure-sensitive adhesive bonded to lid 16 and a layer 36 of a hot melt adhesive bonded to sheet 18, with an intermediate layer 38 being sandwiched therebetween. Intermediate layer 38 may be a polymeric scrim, nonwoven fabric, woven fabric, foam, or film made, for example, from polyethylene, polyester, nylon, etc., or any combination thereof. For example, a hot melt adhesive may be coated over sheet 18 and a nylon nonwoven scrim 38 may be laminated to adhesive layer 36. Pressure-sensitive adhesive layer 34 may be provided in the form of a pressure-sensitive adhesive transfer tape that is adhered to the nylon scrim to provide the insulating element with an attaching member.

Pressure-sensitive adhesives may be of any type suitable for attaching to surfaces of housing components of the battery pack assembly including pressure-sensitive adhesives described above. The type of adhesive suitable for bonding to a housing component may depend upon the material of the walls of the housing component, e.g., high surface energy plastics, low surface energy plastics, metal, etc. The adhesive may be applied directly to the sheet of the insulating element, to a primer on the sheet of the insulating element, or to a barrier layer on the sheet of the insulating element. The adhesive may be sprayed on, or supplied as a transfer adhesive or double coated tape and laminated to the sheet of the insulating element. Adhesive transfer tapes are available from 3M Company under the 3M™ trade designation under the product numbers such as Adhesive Transfer Tape 468MP, Adhesive Transfer Tape 468MPF, Adhesive Transfer Tape 966, and the like.

II. Insulating Element Assembly

The present invention is also directed to an insulating element assembly comprises the above-described insulating element in combination with a housing, wherein the housing comprises one or more of the following components: a lower tray, one or more side walls, and a removable lid that is attachable to the lower tray, the one or more side walls, or both. In this embodiment of the present invention, the insulating element is desirably sized so as to be positioned within a tray cavity formed by the housing components, such as (i) a lower tray, (ii) one or more side walls, and (iii) a removable lid. In one desired embodiment of the present invention, the housing comprises a lower tray having one or more tray side walls attached to the lower tray, and a removable lid that is attachable to the one or more tray side walls, the lower tray, or both, wherein the insulating element is sized so as to be positioned within a tray cavity formed by (i) the lower tray having one or more tray side walls, and (ii) the removable lid. In a further desired embodiment of the present invention, the housing comprises a lower tray and a removable lid having one or more side walls attached to the removable lid, wherein the removable lid is attachable to the lower tray, wherein the insulating element is sized so as to be positioned within a tray cavity formed by (i) the lower tray, and (ii) the removable lid having one or more tray side walls.

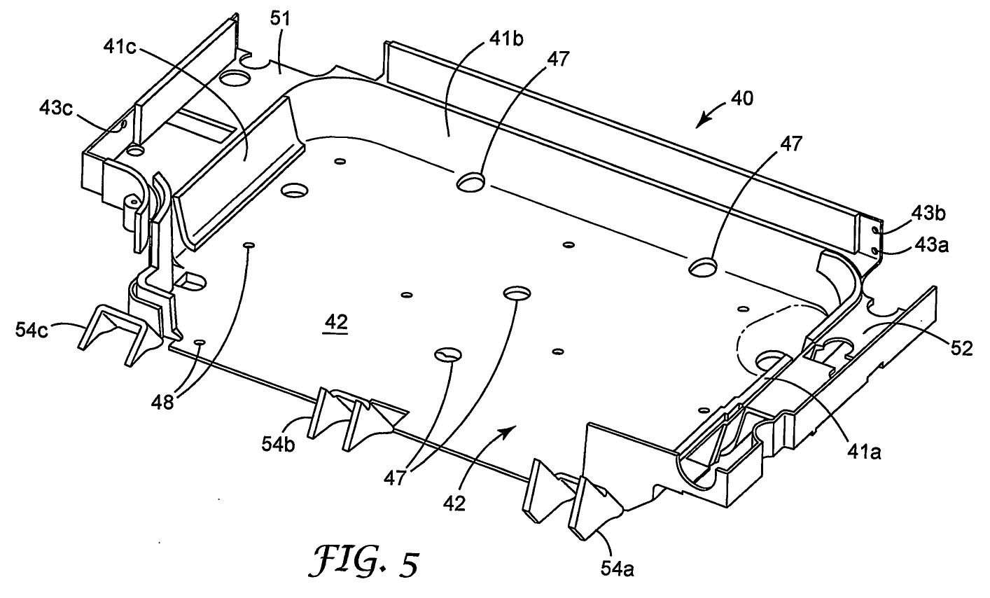

FIG. 5 illustrates an exemplary lower tray 40 having an inner surface 42, and side walls 41a-41c. Although not shown in FIG. 5, an attachable lid may be configured to mechanically attach to exemplary lower tray 40 using one or more attachment devices (e.g., screws) in openings 43a-43c along portions of exemplary lower tray 40. Exemplary lower tray 40 also contains large openings 47 and small openings 48 distributed along inner surface 42. Large openings 47 may be used to position tray 40 within a cavity of a vehicle. For example, pegs or plugs (not shown) may be distributed along a lower surface of a cavity in a vehicle (e.g., see cavity 30 within vehicle body 32 shown in FIG. 1). The pegs or plugs may extend upward through large openings 47 to position tray 40 within the cavity. Small openings 48 may be used to further secure tray 40 to a substrate, such as a vehicle body, by inserting attachment devices (e.g., screws) through small openings 48 and into a substrate.

As discussed above, exemplary lower tray 40 can be made of a plastic, a metal (such as, for example, iron, steel, aluminum, magnesium, etc.), or a combination thereof. The lower tray may be transportable or may be fixed and optionally removable from a given location, such as a location within a vehicle. In one exemplary embodiment of the present invention, exemplary lower tray 40 is fixed to a cavity of a vehicle (such as shown in FIG. 1). In this embodiment, exemplary lower tray 40 may comprise (i) area 51 suitable for an air supply and/or inlet for supplying air to a battery pack positioned within a tray cavity formed by tray 40 and an attachable lid (not shown), and (ii) area 52 suitable for an air outlet, if desired, for removing air from the tray cavity. Alternatively, air may be supplied via an air supply and then circulated within the tray cavity. As shown in FIG. 5, exemplary lower tray 40 may be in proximity to wedges 54a-54c attached to a lower surface of a cavity within a vehicle body (not shown). Wedges 54a-54c are designed to force a battery pack (positioned within tray 40) upward during a rear impact collision of a vehicle. In such a collision, upward movement of the battery pack is believed to minimize damage to power modules (see power modules 12 of FIG. 1) within the battery pack.

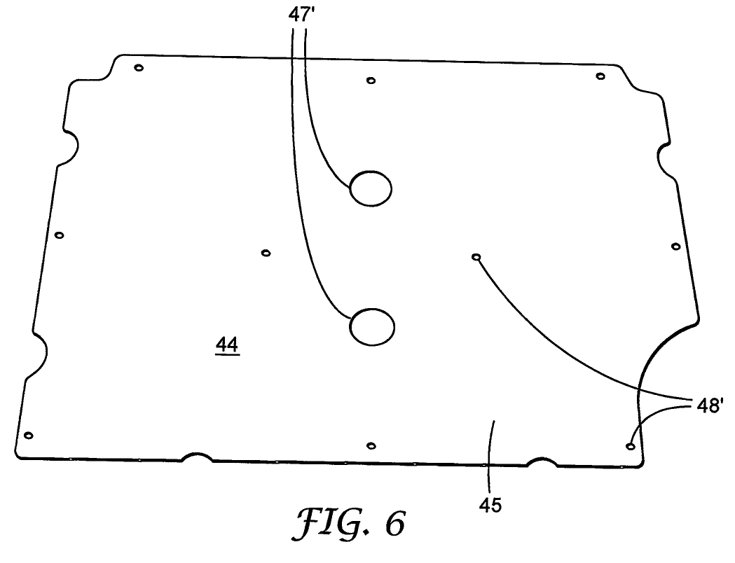

An exemplary sheet of inorganic fibers suitable for use with exemplary lower tray 40 is shown in FIG. 6. As shown in FIG. 6, sheet 45 may have a pattern 44 suitable for mounting onto inner surface 42 of lower tray 40. Pattern 44 comprises a sheet of inorganic fibers, wherein the sheet surface contains large openings 47′, as well as, small openings 48′ therein. Large openings 47′ and small openings 48′ in pattern 44 of sheet 45 correspond to large openings 47 and small openings 48 within surface 42 of lower tray 40 shown in FIG. 5. Such openings may be useful for positioning and attaching sheet 45 to lower tray 40. As discussed above, pegs or plugs may extend through large openings 47 (and large openings 47′) in order to position lower tray 40 (and sheet 45) within a cavity of a vehicle body. Small openings 48′ in pattern 44 of sheet 45 may be used to mechanically attach sheet 45 to lower tray 40 and/or a cavity of a vehicle body. Alternatively, as discussed above, other attachment members, such as an adhesive, may be used to attach sheet 45 to lower tray 40.

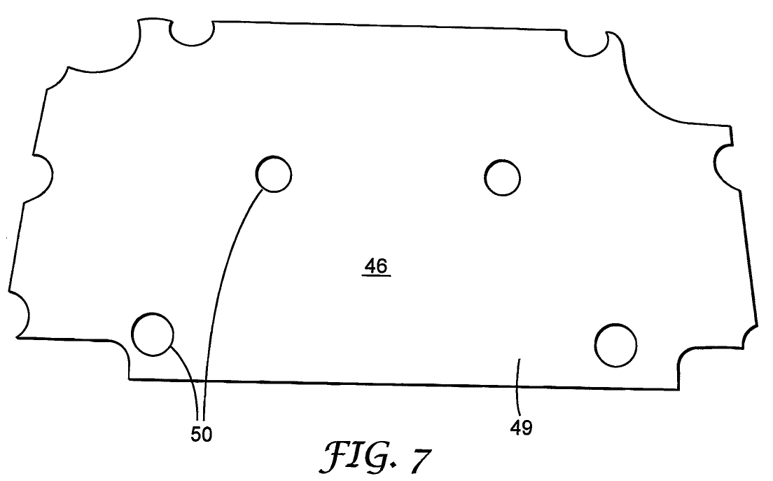

Although an attachable lid is not shown, an exemplary sheet of inorganic fibers suitable for use with an attachable lid and exemplary lower tray 40 is shown in FIG. 7. As shown in FIG. 7, sheet 49 may have a pattern 46 suitable for mounting onto an inner surface of an attachable lid for use with exemplary lower tray 40. Similar to pattern 44, pattern 46 of sheet 49 comprises large openings 50 therein. Large openings 50 may correspond to openings within a surface profile of an attachable lid. Such openings may be useful for (i) positioning and/or attaching sheet 49 to the attachable lid, and/or (ii) providing an opening for pegs or plugs on an inner surface of the attachable lid to extend through, wherein the pegs or plugs are used as spacers to insure an air passage (see air passage 25 in FIG. 1) between an upper surface of a battery pack and a lower surface of sheet 49 positioned above and spaced from a battery pack.

One or more additional sheets of inorganic fibers may be mounted onto inner surfaces of side walls separate from or attached to the lower tray and/or the attachable lid. As discussed above, the one or more sheets, mats or other thin-walled structures used to form the insulating element of the present invention together form an insulating cavity, which may be used to insulate a battery pack from undesirable low temperatures. As shown in FIGS. 6-7, individual sheets having a desired pattern may be made to correspond to a surface profile of the lower tray, an attachable lid, and/or one or more side walls of the housing, and be mounted thereon. In this embodiment, the steps of forming a tray cavity with the housing components (i.e., attaching the tray, side wall(s), and lid to one another as needed to form a tray cavity) simultaneously form an insulating cavity on inner surfaces of the tray cavity. Alternatively, as described above, a single sheet of inorganic fibers may be configured to correspond to the inner surfaces of a tray cavity formed by the housing components. In this alternative embodiment, the single-sheet insulating element may comprise a molded insulating element as described above.

As noted above with regard to the combination of sheet members to form an insulating cavity, the insulating element assembly of the present invention may have a variety of configurations. For example, the insulating element assembly may comprise a tray having a single side wall extending along a perimeter of the tray, such as when the tray has a circular shape. In other embodiments, the tray may comprise eight or more side walls extending along a perimeter of the tray, such as when the tray has an octagonal shape. Further, the one or more side walls may extend along a perimeter of the lid as oppose to the tray as shown in FIG. 5. In other embodiments, both the tray and the lid may have one or more side walls extending along the perimeters of the tray and lid. Any combination of a tray, side wall(s), and a lid may be used in the present invention as long as the combination forms a tray cavity suitable for containing an insulating element for insulating an object, such as a battery pack.

The insulating element and insulating element assembly of the present invention provide the advantage of good thermal insulation at a minimal sheet thickness. By minimizing the sheet thickness, space can be conserved, which is an important consideration for applications such as, for example, automobiles, aircraft, watercraft and other such vehicles. Conserving space is particularly important in automobiles where a limited amount of space is typically available for each of the components used in the vehicle. Accordingly, it is desirable for the insulating cavity formed by the insulating element of the present invention to have dimensions substantially equal to or slightly larger than (i.e., to provide air passages) the dimensions of the object to be insulated, such as a battery pack. Further, in one embodiment of the present invention, it is desirable for the insulating element forming the insulating cavity to have a substantially uniform thickness corresponding to an average thickness of the above-described sheet, mat, or thin-walled structure used to form the insulating element (i.e., no overlap of one sheet member onto another sheet member). In addition, it is desirable for the housing components (i.e., tray, side wall(s) and lid) to have a minimal wall thickness to minimize the space needed for the insulating element assembly.

III. Battery Pack Assembly

The present invention is further directed to a battery pack assembly comprising a battery pack and (i) the above-described insulating element, or (ii) the above-described insulating element assembly. The battery pack may be positioned within an insulating cavity of the insulating element or the insulating element assembly to provide protection from undesirable low temperatures.

Battery packs are known and include, but are not limited to, those disclosed in U.S. Pat. No. 6,445,582 and European Patent No. EP 1,202,359 A2, the subject matter of both of which is incorporated herein by reference in their entirety. The battery pack assembly of the present invention may be placed in a number of places in a vehicle so as to conserve space such as, for example, a well or cavity sized to receive the battery pack assembly and formed in the passenger compartment (e.g., under a seat or floor mat), in a cargo compartment (e.g., in the floor of the trunk of a car or the area in the back of an Sport Utility Vehicle), and possibly in the engine bay, etc. of a vehicle. The thinness of the sheet(s) or mat(s) used to form the insulating element of the present invention, which have a high insulating value is particularly advantageous in self-contained climate-controlled battery packs for hybrid vehicles where space is limited for the battery packs. Such battery packs typically include a heating unit and an air conditioning unit to maintain the temperature within the air chambers of the pack within an optimum temperature range. Minimizing the space for the insulating material can allow more space in the air passages for circulating air to perform the heating and cooling functions in the battery pack. This can reduce the number of heating and/or cooling cycles and cycle times required to maintain the battery pack within the desired temperature range. This, in turn, can extend the life of the air-moving device (e.g., the fan or blower motors), can improve the efficiency of the batteries, and prolong battery life.

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLE 1

### Preparation of Insulating Elements for a Battery Pack

An exemplary insulating element in the form of a sheet or mat was prepared by dispersing 90 parts of bulk aluminosilicate fibers having an approximate composition of about 50% alumina and about 50% silica (available under the CERAFIBER™ trade designation from Thermal Ceramics Co.) in water within a Waring blender to form a dilute slurry (approximately 1% solids). The slurry was placed under a propeller mixer and 18.2 parts of a 55% solids ethylene vinyl acetate latex were added and mixed. A solution containing 10 grams of alum in 3000 ml of water was added during mixing to coagulate the formed latex. The slurry was then formed into a sheet on a screen, dewatered, and dried to form a ceramic fiber mat having a thickness between about 2.2 to about 2.7 mm, and a basis weight of between about 800 to 900 gsm (grams per square meter).

To form an adhesive coated mat, a hot melt adhesive (Bostik Polyester 105 Web Adhesive available from Bostik Corp. (Middleton, Ma.)) was placed over a portion of the ceramic fiber mat and heated so that the adhesive was between about 110 and about 140° C. A 0.1 mm thick spunbonded nylon nonwoven scrim having a basis weight of 29 g/m² (0.85 oz/yd²) (available under the CEREX™ trade designation) was laminated to the adhesive using a nip roll to provide a surface on the mat for anchoring a pressure-sensitive adhesive. A pressure-sensitive adhesive transfer tape was adhered to the nylon scrim to provide an insulating mat with an attaching member.

Alternatively, a pressure-sensitive adhesive coated film was used to provide a surface for anchoring a pressure-sensitive adhesive. A 0.07 mm thick cast polypropylene film was coated with a pressure-sensitive adhesive at a coating weight of about 25 grams/m² to form a sheet. The back side of the film had been treated with a urethane backsize coating. The adhesive side was laminated to one major surface of the ceramic fiber mat. An acrylic adhesive transfer film (acrylic) was laminated to the polyurethane backsize to form an insulating mat suitable for attaching to a surface of a battery pack or housing component.

### EXAMPLE 2

### Testing Insulating Elements for Water Absorption and Water Desorption

The ceramic fiber mats formed in Example 1 were tested for water absorption, water desorption, and thermal conductivity as follows using the methods below.

Water Absorption

A water absorption test was used to show the tendency of insulating element materials to absorb moisture under high humidity and temperature. Five samples of ceramic fiber mat were formed having an approximate thickness of about 2.75 mm and five samples having an approximate thickness of about 2.5 mm. The samples were weighed and then placed in a humidity chamber set at 37.7° C. (100° F.) and 100% relative humidity. All of the samples were made using the procedure and materials of Example 1. The samples were then weighed at the times indicated in Table 1 below and the weight gain due to moisture absorption was recorded in weight %.

TABLE 1
Ceramic Fiber Mat Sample Weights Over Time

| Time | 2.75 mm Sample | 2.5 mm Sample |
|---|---|---|
| Hours | % weight gain | % weight gain |
| 0.50 | 1.76 | 3.17 |
| 1.00 | 2.99 | 4.43 |
| 4.50 | 20.96 | 28.86 |
| 7.50 | 34.64 | 51.45 |
| 23.50 | 115.11 | 174.07 |
| 37.50 | 183.63 | 225.98 |
| 54.50 | 230.12 | 247.05 |
| 71.50 | 235.83 | 251.74 |
| 74.50 | 237.40 | 251.11 |

Water Desorption

A water desorption test was used to show the ability of insulating element materials to desorb water (i.e., dry) over time, which is an indication of how well the insulating element will dry out if it has been saturated with water. Generally, higher desorption rates are desired. In this test, a sample of a ceramic fiber mat was prepared using the method and materials of Example 1. The sample, weighing 19.07 grams was soaked in water at room temperature for 18 hours. The sample was then removed from the water and weighed. The water weight was calculated (wet sample weight—dry sample weight) and this weight was recorded as 100% water. The sample was then hung vertically and allowed to drip dry. The sample was weighed at various time intervals indicated in Table 2 below.

TABLE 2
Ceramic Fiber Mat Sample Weights Over Time

| Time - hours | Wet Weight - grams | Water Weight - grams | Water - % |
|---|---|---|---|
| 0 | 59.07 | 40.00 | 100 |
| 1 | 55.63 | 36.56 | 91.4 |
| 2.5 | 48.97 | 29.90 | 74.8 |
| 4.5 | 38.68 | 19.61 | 49.0 |
| 6 | 31.42 | 12.35 | 30.9 |
| 7 | 26.99 | 7.92 | 19.8 |
| 22 | 19.07 | 0.00 | 0 |
| 24.5 | 19.07 | 0.00 | 0 |
| 29 | 19.07 | 0.00 | 0 |
| 31 | 19.07 | 0.00 | 0 |

Thermal Transmission

A thermal conductivity test was used to show the thermal conductivity through a sheet suitable for use as an insulating element (e.g., a ceramic fiber mat) from room temperature to 500° C., an indication of the insulating capabilities of the sheet. In this test, a sample measuring 50.8 mm by 50.8 mm was placed between two metal platens having the same dimensions. The platens were wired to thermocouples, and were capable of being heated. One of the platens was heated to 100° C., and in 100° C. increments up to 500° C. The platen was held at each temperature for 15 minutes. The temperature on the heated platen is referred to herein as the “Hot Side Temperature,” while the temperature on the unheated platen is referred to herein as the “Cold Side Temperature.” In this test, it was desirable to have a difference between the Cold Side Temperature and the Hot Side Temperature as great as possible to provide a maximum insulating value.

Two sample sheets suitable for use in an insulating element were prepared using the method and materials as in Example 1. The mats did not have an adhesive or scrim lamintaed to them. Sample 1 had a basis weight of 1400 gsm and a nominal thickness of about 4.4 mm. Sample 2 had a basis weight of 866 gsm and a nominal thickness of 2.5 gsm. Both samples were tested for thermal transmission as described above.

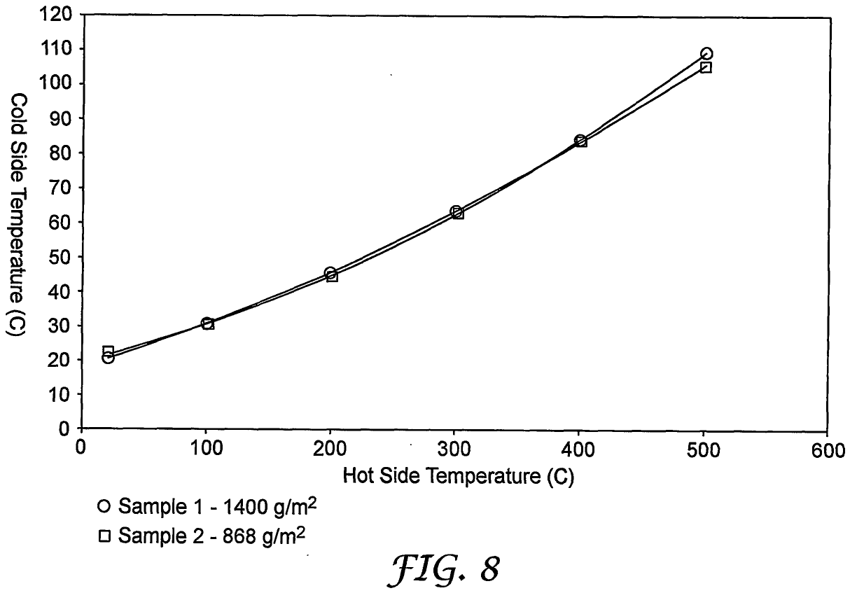

The Cold Side Temperature vs Hot Side Temperature characteristics of Samples 1 and 2 are shown in the graphs of FIG. 8. The graphs indicate only a slight difference in insulating value between the two thicknesses of mat. The thinner sample provided the same insulating performance as the thicker sample.

The insulating element sheets provide a high level of thermal resistance at minimum thickness. This allows the air gap around the battery pack to remain substantially unobstructed, reducing the back pressure and/or resistance of air flow throughout the battery pack assembly. One potential benefit is that the blower or fan motors will cycle less and run for shorter periods of time, thereby extending the life of the motors.

### EXAMPLE 3

### Preparation of a Molded Insulating Element for a Battery Pack

A molded insulating element was prepared as follows. A slurry comprising 94 gallons of water, 5670 grams (12.5 lbs.) of annealed ceramic fiber (as disclosed in U.S. Patent No. 5,250,269 (Langer) and PCT Published Patent Application No. WO 00/75496 A1(Langer)), 1066 grams (2.35 lbs.) of AIRPLEX 600BP latex (an aqueous emulsion of ethylene vinyl acrylate terpolymer (Philadelphia, Pa.) and added in the form of a 55 wt % emulsion), 1082 grams (4.15 lbs.) of active aluminum sulfate (added in the form of a 50 wt % aluminum solution) and 91 grams (0.2 lbs.) of defoamer (NALCO Foamaster). On a dry weight basis (i.e. without water), the composition is 78 wt % annealed fiber, 8 wt % latex, 13 wt % aluminum sulfate and 1 wt % defoamer was prepared in a stainless steel mixing tank using the following steps.

The slurry was prepared in the mixing tank of a traditional pilot papermaking process line. Water and defoamer were first added to the mixing tank. An in-line propeller mixer was started at a relatively medium to high speed for mixing. The ceramic fiber was added slowly and stirring speed was increased to the mixers maximum level to maintain sufficient ceramic fiber dispersion with no visible large flocs. When all of the ceramic fiber had been added to the drum, the latex was added and mixed in for approximately 5 minutes. The aluminum sulfate solution was then added slowly. When all of the components were inside the tank, mixing continued for approximately another 10 minutes or until the slurry was uniform. The slurry was then pumped into two 55 gallon, plastic-lined drums.

The slurry was molded using a mold/die and vacuum technique to dewater the slurry into a shape of the mold/die similar to the process described in U.S. Pat. 6,596,120. An internal skeleton was designed and constructed to allow the desired vacuum pull/vacuum distribution through the part. The outside section of the die was in the form of a battery pack. After the die in the desired size and shape was submerged into the slurry for a period of about 5-10 minutes, a part of the desired fiber weight, thickness and density was produced. The formed part in the wet condition was then released from the forming die and dried in an oven at either room temperature overnight or 150° C. (300° F.) for about 2 hours.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. An insulating element for a battery pack comprising:
a lower sheet member;
at least one side wall sheet member; and
an upper sheet member;
wherein each sheet member comprises a sheet or mat of inorganic fibers, and the sheet members combine with one another to form an insulated cavity bounded by (i) the lower sheet member, (ii) the at least one side wall sheet member, and (iii) the upper sheet member; and
wherein one or more sheet members further comprise an attaching member on the sheet member opposite the insulating cavity, said attaching member comprising a pressure-sensitive adhesive layer, a hot melt adhesive layer, a structural adhesive layer, a hook and loop type fastener, a headed fastener, or a combination thereof.

2. The insulating element of claim 1, wherein the at least one side wall sheet member comprises two or more separate side wall sheet members, each of which is attached to the lower sheet member, the upper sheet member, or both.

3. The insulating element of claim 1, wherein each sheet member comprises a nonwoven fabric of inorganic fibers.

4. The insulating element of claim 1, wherein said inorganic fibers are alumina fibers, aluminosilicate fibers, glass fibers, graphite fibers, boron fibers, alumina borosilicate fibers, calcia-magnesium silicate fibers, silicon carbide fibers, annealed ceramic fibers, quartz fibers, or a mixture thereof.

5. The insulating element of claim 3, wherein said inorganic fibers are glass fibers, refractory ceramic fibers, or a mixture thereof.

6. The insulating element of claim 1, wherein each sheet member consists essentially of sized or unsized inorganic fibers.

7. The insulating element of claim 1, wherein the attaching member comprises a pressure-sensitive adhesive layer.

8. The insulating element of claim 1, wherein the attaching member comprises a pressure-sensitive adhesive layer and a hot melt adhesive layer between the sheet member and the pressure-sensitive adhesive layer.

9. The insulating element of claim 8, wherein one or more sheet members further comprise an intermediate layer between the hot melt adhesive layer and the pressure sensitive adhesive layer.

10. The insulating element of claim 9, wherein the intermediate layer comprises a polymeric scrim, a nonwoven fabric, a woven fabric, a foam, a film, or a combination thereof.

11. The insulating element of claim 1, wherein the sheet members are portions of a single sheet.

12. The insulating element of claim 1, wherein one or more of the sheet members are molded sheet members.

13. A molded insulating element for a battery pack comprising one or more molded sheet members, wherein each sheet member comprises a sheet or mat of inorganic fibers, and the sheet members combine with one another to form an insulated cavity bounded by (i) a lower sheet member, (ii) at least one side wall sheet member, and (iii) an upper sheet member.

14. The molded insulating element of claim 13, wherein at least a portion of the at least one side wall sheet member is in a plane substantially perpendicular to the lower sheet member, the upper sheet member, or both; and the at least one side wall sheet member forms one or more side walls along a perimeter of the lower sheet member, the upper sheet member, or both.

15. The molded insulating element of claim 13, wherein each of the sheet members is a molded sheet member.

16. An insulating element assembly comprising the insulating element of claim 1, and a housing comprising (i) a lower tray, (ii) one or more tray side walls, and (iii) a removable lid, said insulating element sized so as to be positioned within a tray cavity formed by (i) the lower tray, (ii) the one or more tray side walls, and (iii) the removable lid.

17. A battery pack assembly comprising the insulating element of claim 1 and a battery pack.

18. The battery pack assembly of claim 17, wherein the battery pack is positioned within the insulating cavity of the insulating element.

19. A battery pack assembly comprising the molded insulating element of claim 13 and a battery pack.

20. The battery pack assembly of claim 19, wherein the battery pack is positioned within the insulating cavity.

21. A battery pack assembly comprising the insulating element assembly of claim 16 and a battery pack.

22. An insulating element assembly for a battery pack comprising:
(a) a housing comprising:
a lower tray,
one or more side walls, and
a lid that is attachable to the tray, the one or more side walls, or both, said housing having a tray cavity formed by (i) the lower tray, the one or more side walls, and (iii) the lid; and
(b) an insulating element comprising:
a lower sheet member;
at least one side wall sheet member; and
an upper sheet member;
wherein each sheet member comprises a sheet or mat of inorganic fibers, and wherein the sheet members combine with one another to form an insulated cavity within the tray cavity.

23. The insulating element assembly of claim 22, wherein the lower sheet member is positioned on an inner surface of the lower tray; the at least one side wall sheet member is positioned on an inner surface of each of the one or more side walls; and the upper sheet member is positioned on an inner surface of the lid.

24. The insulating element assembly of claim 22, wherein the at least one side wall sheet member is attached to the lower sheet member, the upper sheet member, or both.

25. The insulating element assembly of claim 22, wherein the insulating element comprises a single sheet of inorganic fibers comprising the lower sheet member, the one or more side wall sheet members, and the upper sheet member.

26. The insulating element assembly of claim 22, wherein one or more sheet members of the insulating element comprise molded sheet members.

27. The insulating element assembly of claim 22, wherein the one or more side walls are permanently attached to the tray, the lid, or both; and the lid is attachable to the tray, the one or more side walls, or both.

28. The insulating element assembly of claim 22, wherein each sheet member consists essentially of sized or unsized inorganic fibers.

29. The insulating element assembly of claim 22, wherein one or more sheet members are attached to the housing via an attaching member on the one or more sheet members, said attaching member comprising a pressure-sensitive adhesive layer, a hot melt adhesive layer, a structural adhesive layer, a hook and loop type fastener, a headed fastener, or a combination thereof.

30. A battery pack assembly for providing power for a vehicle comprising:
a battery pack; and
the insulating element assembly of claim 22.

31. A battery pack assembly for providing power for a vehicle comprising:
a battery pack; and
an insulating element to insulate said battery pack, said insulating element comprising:
a lower sheet member;
at least one side wall sheet member; and
an upper sheet member;
wherein each sheet member comprises a sheet or mat of inorganic fibers, and wherein the sheet members combine with one another to form an insulated cavity at least partially surrounding said battery pack, said insulated cavity being bounded by (i) the lower sheet member, (ii) the at least one side wall sheet member, and (iii) the upper sheet member.

32. The battery pack assembly of claim 31, further comprising a housing, said housing comprising (i) a lower tray, (ii) one or more side walls, and (iii) a lid that is attachable to the lower tray, the one or more side walls, or both; said battery pack being mountable in said housing with said insulating element being disposed between said battery pack and said housing.

33. The battery pack assembly of claim 31, further comprising a heater for warming said battery pack.

34. A vehicle comprising the battery pack assembly of claim 31.

35. The vehicle of claim 34, wherein the vehicle is a hybrid vehicle, which runs on (i) gas or diesel and (ii) electricity.

36. A method of insulating a battery pack in a vehicle comprising:
providing a battery pack;
at least partially surrounding the battery pack with the insulating element of claim 1.

37. A method of maintaining a battery pack in a vehicle within a temperature range, said method comprising:
providing a battery pack;
at least partially surrounding the battery pack with the insulating element of claim 1.
